(19) United States
(12) Patent Application Publication
(10) Pub. No.: US 2006/0168290 A1
(43) Pub. Date: Jul. 27, 2006

(54) System and method for media stream adaptation

(76) Inventor: Eli Doron, Ganei Tikva (IL)

Correspondence Address: PEARL COHEN ZEDEK, LLP, 1500 BROADWAY 12TH FLOOR, NEW YORK, NY, 10036, US

(21) Appl. No.: 11/190,047

(22) Filed: Jul. 27, 2005

Related U.S. Application Data
(63) Continuation of application No. 09/993,941, filed on Nov. 27, 2001, now abandoned.
(60) Provisional application No. 60/253,086, filed on Nov. 28, 2000.

(51) Int. Cl. G06F 15/16

(52) U.S. Cl. 709/231

(57) ABSTRACT

A device accepts a set of configuration parameters relating to components involved in data streaming (e.g., clients or network equipment) and transforms a data stream in response to such configuration parameters, transmitting the transformed data stream onward to a client. Dynamic changes in the configuration parameters may affect the transformations.

### CROSS REFERENCE TO RELATED APPLICATIONS

This application is a continuation of U.S. Ser. No. 09/993,941, filed on Nov. 27, 2001, which claims priority from prior U.S. provisional application 60/253,086, filed 28 Nov. 2000, entitled “Media Stream Bandwidth Adaptation (MSBA).”

### FIELD OF THE INVENTION

The present invention relates to media server output, more specifically to adjusting the parameters (e.g., bandwidth) of such output dynamically and intelligently depending on the needs and capabilities of system components.

### BACKGROUND OF THE INVENTION

In data streaming, data streams are typically sent from a server to a client endpoint. Streaming data may include, for example, any data transmittable from a server to a client in a continuous stream. Data which is commonly streamed includes data such as voice and video data, although other data may be streamed. There are many types of endpoints or clients accepting streamed data, for example cellular telephones and video players on personal computers (PCs). Typically, streaming data is transmitted by a network or series of networks. Components such as software components or hardware components such as routers may be involved in the delivery of streaming data. Each component may have different throughput or other capabilities. For example, a component such as a network segment may be able to handle only a certain bandwidth. Such capabilities may change over time—for example, the bandwidth that is available on a network segment may change with time.

Current streaming methods may require multiple streams, each having different parameters, to be sent from a server, according to the different types of network components and clients. For example, a server streaming a video presentation may have to send one stream for a device or set of devices having certain video decompression and display capabilities, and another stream for a device or set of devices having a different set of capabilities. If different or changing capabilities require the server to produce more than one stream or to respond to changes in capabilities, the load on the server (e.g. its CPU load) may be increased Increasing this load on the server, which is a single point serving multiple clients, increases the overall load on the network.

Therefore, a need exists for a system and method which allows data stream to be manipulated, processed and distributed remotely from the server, to allow for different client and network capabilities, and to allow for a response to changing system capabilities without increasing the load on that server.

### SUMMARY OF THE INVENTION

Embodiments of a system and method of the present invention accept a set of configuration parameters relating to components involved in data streaming (e.g., clients or network equipment) and transform a data stream in response to such configuration parameters, transmitting the transformed data stream onward to a client In further embodiments, dynamic changes in the configuration parameters may affect the transformations.

### BRIEF DESCRIPTION OF THE DRAWINGS

The present invention will be understood and appreciated more fully from the following detailed description taken in conjunction with the drawings in which:

FIG. 1 is a diagram of a network including an embodiment of the present invention.

FIG. 2 depicts a streaming adapter according to an exemplary embodiment of the present invention.

FIG. 3 is a flowchart showing steps for modifying a data stream according an embodiment of the present invention.

FIG. 4 is a flowchart showing a portion of the steps for modifying a data stream according an embodiment of the present invention.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention.

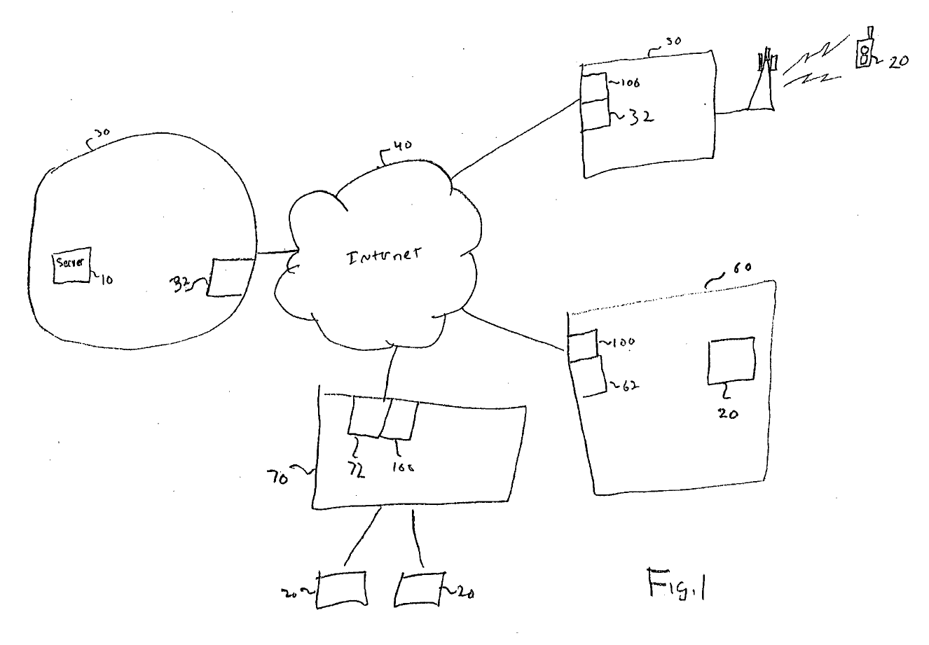

FIG. 1 is a diagram of a network including an embodiment of the present invention. Referring to FIG. 1, server 10 transmits streaming data to clients 20. Server 10 may be any known server streaming data. For example, server 10 may be a streaming server provided by Optibase, Inc., transmitting video data, but may be other types of servers transmitting other types of streaming data Clients 20 may be, for example, a cellular telephone accepting streamed audio or video data, a PC accepting video data and playing the video data on a video player, or other devices such as video phones, a large screen display, or devices in moving vehicles. In alternate embodiments, clients may but may be other types of clients and may accept other types of streaming data. In an alternate embodiment, a server may be a device both sending and receiving streaming data, such as a videophone or PC with videoconference capabilities. In such a case, both the server and client (e.g., another party in the videoconference) may send and receive streaming data.

Various networks may transmit the data. For example, the server 10 may be included in a server enterprise network 30. The streamed data may be transmitted first by enterprise network 30 and then over the Internet 40. A cellular enterprise network 50 may accept streamed data for transmission to certain clients. A client enterprise network 60 may accept data including streamed data for local distribution to clients 20. A point-of-presence (POP) 70 may provide an access point to the Internet 40 for various clients 20, accessing the POP 70 via, for example, telephone lines or other methods. The various networks 30, 40, 50 and 60 may include various components, such as routers, bridges, caches, fiber optic cables, wireless links, and other known network components. The network configuration provided in the Figures is merely exemplary; embodiments of the system and method of the present invention may operate with other network configurations or series of networks.

In an exemplary embodiment, each of networks 30, 50 and 60, and POP 70, include network controllers, respectively network controllers 32, 52, 62 and 72, of known construction, which may help manage and control networks, and may centralize data collection and command distribution. For example, network controllers 32, 52, 62 and 72 may be, for example, a Serving GPRS Support Node (SGSN) supplied by Lucent Technologies or Nokia, or an SIP Proxy server supplied by Cisco. The function of network controllers 32, 52, 62 and 72 may be spread among multiple remotely situated devices. The construction and operation of network controllers is known, and network controllers may exist in varying forms. For example, a workstation or PC may be used to control a network, or various components in one or more locations may be used. In alternate embodiments, network controllers need not be used.

Streaming adapters 100 may be located at various points between the server 10 and clients 20. In FIG. 1, streaming adapters 100 are shown within server enterprise network 30, client enterprise network 60 and POP 70. Preferably, a streaming adapter 100 is located at or near the edge of a network, where that network interfaces with another network. Preferably, a streaming adapter 100 is located at a network bottleneck, so that data (possibly all data) entering the network may flow through the streaming adapter 100. Thus the streaming adapter 100 within the server enterprise network 30 is located near that network's interface with the Internet 40, and the streaming adapter 100 within the client enterprise network 60 is also located near that network's interface with the Internet 40.

In alternate embodiments, a streaming adapter may be located at any other position. For example, a streaming adapter may be co-located or included within a server, may be located at a position in a network not near the network's edge, may be included within or co-located with network equipment such as routers or bridges, or may be located in other networks, such as the Internet.

In an exemplary embodiment, a streaming adapter is a component or processor including one or more DSPs which is programmed to include streaming adapter functionality. Such DSPs may be provided by, for example, Motorola or Texas Instruments. Such devices may have functionality added by known programming methods. In alternate embodiments, a streaming adapter may be any device including streaming adapter functionality. Components which may accept or be modified for such novel functionality are known. For example, a set of DSPs controlled by an external controller, such as a PC or including a microcontroller may be used. A router, proxy server, or other network component, a streaming media server, or other component may include streaming adapter functionality via the inclusion of components or software providing such functionality. For example, a card including a set of DSPs and/or compression software and the appropriate control software may be included in a network component. In further embodiments, a streaming adapter may be formed from the combination of multiple separate components, such as a controller sending remote commands to a DSP or other device.

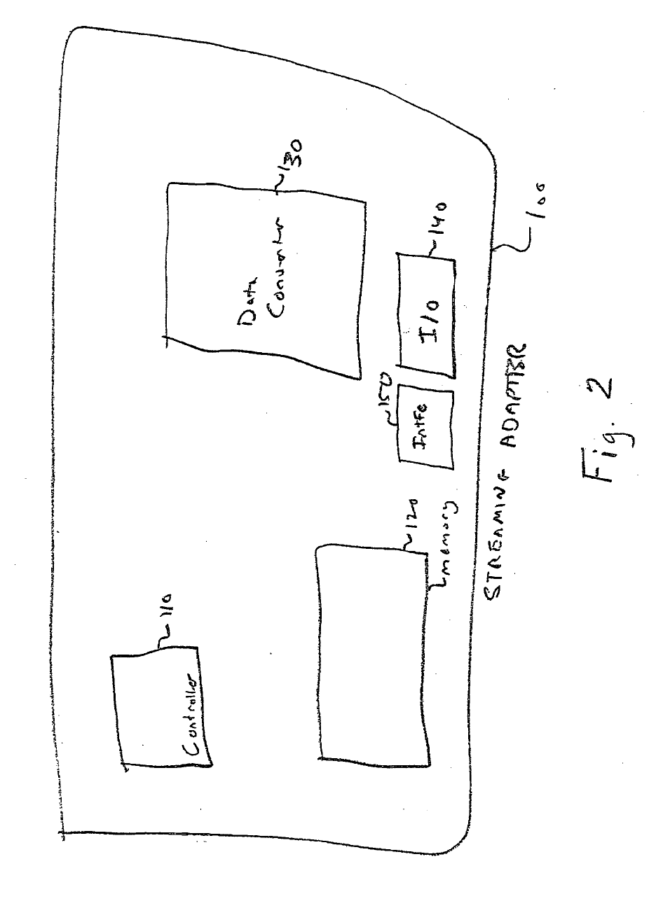

FIG. 2 depicts a streaming adapter according to an exemplary embodiment of the present invention. In an exemplary embodiment, a streaming adapter 100 includes a controller 110, a memory 120, a data converting unit 130, a data I/O unit 140, and a controller interface 150 providing a connection to a network or networks, or to other devices. Memory 120 may be, for example, a RAM, and may include various combinations of components. The data converting unit 130 may be the combination of the controller 110 and software stored in, for example, the memory 120 in a streaming adapter, or may be another unit, for example a digital signal processor (DSP) unit. In alternate embodiments, a streaming adapter may be of different configurations and include different components.

A streaming adapter may communicate with and gather information from various components, such as a server 10, clients 20, and network components, through various methods. Preferably, a streaming adapter communicates with components via the networks connecting them, but other methods may be used. In an exemplary embodiment, the streaming adapter 100 communicates with components and gathers and requests data using real time control protocol (RTCP), Simple Network Management Protocol (SNMP), and/or possibly other protocols.

A streaming adapter may gather information by receiving information sent from components either regularly or in response to changing conditions. For example, a network component may periodically transmit information regarding load and capabilities. A change in client status (e.g., a mobile client changing speed, a client no longer requiring a data stream, etc.) may be transmitted to the streaming adapter by a client 20. A network controller, client 20, server 10, or other component may notify the streaming adapter of the addition or deletion of a client 20. Furthermore, a streaming adapter may gather information by polling or otherwise requesting information from components. Information may be received in other manners, for example through other components gathering network or other information. For certain components, additional functionality may be added, through known methods, allowing the component to transmit configuration information to the streaming adapter or to allow the streaming adapter to poll the component.

In an exemplary embodiment, configuration data or information may include information on the components themselves, such as the bandwidth or current load of individual components or networks, network topologies, the capabilities of servers, the data format or decompression capabilities of clients, or other information. Configuration information may include quality requirements; for example, a certain client or set of clients may have a minimum quality requirement, where too much data compression may cause unacceptable quality degradation or information loss. Furthermore, configuration information may include data on load and usage, for example, which clients are receiving which data streams, which servers are sending data streams, how those data streams are being modified, and the paths that those data streams are being sent. Configuration information may include information sent in a client streaming media request.

In a streaming adapter 100 shown in FIG. 2, configuration information may, for example, be stored in a streaming adapter memory 120. In alternate embodiments, the configuration information may be stored in other manners; for example in a device other than or separate from the streaming adapter.

Configuration information may be accepted at different times. For example, configuration information may be accepted on the initialization or startup of a streaming adapter. Furthermore, configuration information may be accepted when a component is added or dropped. For example, when a client requests a data stream, the client, a network controller, or another component, may send configuration information, including information regarding the nature of the data stream request and the identity of the client (possibly including location or address information), to a streaming adapter. Configuration information may be accepted when a component changes; for example, when the load on a network or network component changes.

Configuration information may be pre-programmed into the streaming adapter, downloaded or sent from an external device, such as the server, or may be taken from network components themselves. For example, the streaming adapter may poll a client or server, requesting information on what type(s) of compression or decompression algorithm(s) the component uses.

In an exemplary embodiment, a streaming adapter 100 accepts a data stream from the server 10 and resends the data stream to one or more clients 20, usually but not always in modified form. The streaming adapter 100 accepts configuration data from components such as network components, clients 20, or servers, and may modify the data to suit network, client 20 or other needs.

In an exemplary embodiment, in operation, a client 20 makes a request to a streaming data server 10. The network controller for the network or system in which the client 20 is located or through which the client is served preferably intercepts such streaming data requests.

If the streaming data server 10 is not yet streaming the requested data to a client 20 in the relevant network, the network controller forwards the streaming data request to the server 10 and preferably notifies the relevant streaming adapter 100 of the request. The network controller may send configuration information, including information describing the data stream and the client 20 and server 10 identity, location or address, to a streaming adapter 100, and the information may be stored in, for example, the streaming adapter's memory. The server 10 provides the data via known methods. For example, a client 20 requests a video clip from the server 10, and the server 10 streams the data to the address of client 20 using known video streaming methods. The streaming adapter 100 receives packets entering the network, forwards packets not including streaming data onward, and processes packets containing streaming data, as discussed below. The processed packets are sent to the client 20 which displays the data on a video player on the client 20

If the streaming data server 10 is already streaming the requested data to a client 20 in the relevant network other than the requesting client 20, the network controller forwards the streaming data request to the streaming adapter 100 which provides the data stream to the requesting client 20. The streaming adapter 100 may stream a data stream it is receiving to multiple clients 20 at the same time, reducing the load on both the server 10 and the network connections between the server 10 and the streaming adapter 100.

In an exemplary embodiment, a streaming adapter 100 may accept multiple data streams, each having different data, from multiple data servers, and distribute each of those streams to multiple clients 20. A streaming adapter 100 may output multiple data streams each having different content (each based on a different input stream) and may output multiple sets of data streams, where each set has the same content, but within each set each data stream may be sent to a different client or may have different transcoding, compression, error correction, or other formatting differences.

In alternate embodiments, the system and method of the present invention may act in different manners. For example, it is not required that a network controller forward streaming data requests to a streaming adapter. In other embodiments, other entities, such as a client or a server, may forward such request to a streaming adapter, or the streaming adapter may detect such requests. A streaming adapter may serve an area other than an enterprise network; for example, a streaming adapter may be located near a server. A streaming adapter need not intercept all packets flowing through the network on which it is located.

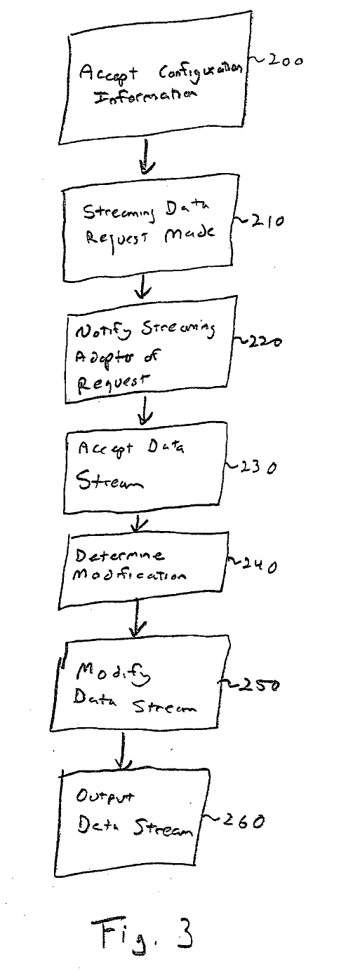

FIG. 3 is a flowchart showing steps for modifying a data stream according an embodiment of the present invention.

Referring to FIG. 3, in step 200, the streaming adapter accepts configuration information.

In step 210, a client makes a streaming data request to a data server.

In step 220, the streaming adapter is notified of the streaming data request. In an exemplary embodiment, the streaming adapter accepts the data request from a network controller; in alternate embodiments, the streaming adapter may accept a data request in other manners; for example directly from a client. The client and client configuration data may be known to the streaming adapter from step 200, above, or may be provided in this step. As discussed above, information regarding the request may be provided to the streaming adapter by, for example, the client and/or a network controller.

In step 230, the streaming adapter accepts a data stream from a data server.

In step 240, the streaming adapter determines whether and how to modify the data stream. In various embodiments, various considerations may be used to determine whether a data stream is to be modified. Preferably, the data stream is compressed, or has its compression altered, setting the data stream bandwidth so that it is below a limit or allocation, while allowing the data stream to maintain a minimum quality requirement. The limit or allocation may be based on network requirements or capabilities, network load, client parameters, or other information.

In an exemplary embodiment, the streaming adapter considers the current capabilities of the relevant network and the client requesting the data in determining whether and how to modify the data stream. In alternate embodiments, other considerations may be used.

The streaming adapter considers the bandwidth requirements and possibly other characteristics of the data stream, the current load and topologies of the network or networks which are able to transmit data between the server and client, and the bandwidth of these networks, and determines whether the networks are able to transmit the data without compression. If not, the data stream is to be modified. In alternate embodiments, other considerations or parameters based on networks may be used.

The streaming adapter considers the various characteristics of the data stream and the capabilities of the client to determine whether the client is able to receive the data stream un-modified. If not, the data stream is to be modified. Such capabilities may include, for example, whether or not the client can accept the data stream in the format (e.g., the compression format, the data format, etc.) as provided to the streaming adapter by the server, and how many data streams a client may accept. For example, the server may transmit in MPEG-2 format, while the client may only be able to receive in MPEG-4 format. In alternate embodiments, other considerations or parameters based on clients may be used.

In step 250, if the data stream is to be modified, the streaming adapter modifies or transforms the data stream. In an exemplary embodiment, the streaming adapter determines how much the streaming data should be compressed, based on the network bandwidth and load for the network components which are to deliver the data to the client, and the bandwidth requirements of the streaming data. In one embodiment, an upper bandwidth limit or allocation may be assigned to the data stream being sent to a particular client. Parameters which may be used to modify the amount of compression may include, for example, quantifiers or the use of motion vectors. Further considerations may include any minimum quality requirement or compression limitations or capabilities of the client. In an exemplary embodiment, the streaming adapter may accept a data stream and modify the data stream in different ways for different clients.

The data stream is modified based on the chosen method. In an exemplary embodiment, the data stream is transcoded. When used herein, transcoding includes transforming one compression format to another. Other functions than transcoding may be used—for example, altering data formats or error check capabilities. For example, a video data stream sent by a server and accepted by a streaming adapter may be altered from MPEG-2 format and sent to the client in MPEG-4 format. The streaming adapter inputs the data stream from the server and outputs the modified data stream.

In alternate embodiments, modifications or transformations other than transcoding may be performed. For example, a streaming adapter may simply compress the data, or may modify the data format of a stream to be compatible with one or more clients, may time delay or cache a data stream, or may perform other functions, such as adding error correction capabilities.

In step 260, the streaming adapter sends the output data stream to a client, through known methods. The client accepts the modified data stream and, for example, displays or otherwise outputs the data to the user. For example, an audio program or a video program may be output. In an exemplary embodiment, the streaming adapter may convert a data streams from a server and transmit the data stream to multiple clients; the data stream may be modified in different ways for different clients, or different clients may receive the identical output. Multiple network paths may be used.

In an exemplary embodiment, when deciding if and how to modify data streams, the streaming adapter takes into account the overall needs of all current clients, and the overall limitations of the network components used to transmit data to those clients. Furthermore, the modification of data streams to current clients may be modified based on changing conditions and different clients competing for resources.

For example, when a new client makes a streaming data request which will impact network components by increasing the load on those components, the streaming adapter may calculate the added load that the network is capable of absorbing, and use this as a limitation when deciding how to modify the data stream for the new client. Furthermore, the additional load placed on the network by the new client may cause the streaming adapter to modify the conversion methods for existing clients. A new client may lower the bandwidth one or more networks may handle, causing higher data compression to be used for a set of clients. An exiting client may cause the reverse, a lowering in the amount of data compression used. The minimum requirements for each client, if existing, may be factored in.

In an alternate embodiment, a streaming adapter may pass streaming data from two endpoints or clients which are each streaming data from and receiving data from each other. For example, a streaming adapter (or set of streaming adapters) may pass data between two clients engaged in a videoconference. Such data may be streamed data or other data. In such a case, each endpoint acts as both a server transmitting streamed data and a client receiving streamed data. More than one streaming adapter may be used; for example, one streaming adapter for each data direction.

By transferring the need to respond to client requests, the need to create multiple data streams tailored to individual clients, and other processing from a server to a streaming adapter, the load on the server is reduced. Furthermore, the load on the network may be reduced, as a single stream may be transmitted to a streaming adapter, which then splits the stream. Additional functionality, not available with current data streaming devices, may be provided by a streaming adapter.

In an exemplary embodiment, the method of converting data, or the parameters for the data conversion, may be changed dynamically. For example, the load or capabilities of a network may change, allowing the streaming adapter to send more data via a network, or forcing the streaming adapter to lower the amount of data it sends via a network. The capabilities of a client may change. For example, a client may be operating in a mobile vehicle. When the vehicle stops, the rate at which the client may accept data may increase, and thus the streaming adapter may increase the bandwidth send to the client by, for example, lowering the amount of data compression that takes place. When the vehicle resumes motion, the reverse may take place. Any other dynamic parameter change may take place.

Such dynamic change may occur while the streaming adapter is converting one or more data streams, and may cause the streaming adapter to change the methods it uses to convert those data streams. Such dynamic change may also occur in a manner not causing the streaming adapter to change the methods it uses to convert those data streams. For example, a network component currently uninvolved in a data streaming operation may transmit information regarding a change in load; such information might not cause a change in the current data streaming operations of the streaming adapter, but may affect future streaming operations.

Dynamic configuration data may arrive at the initiation of a client. For example, the load on a client which had previously required a certain data compression regime may change, allowing for a different data compression regime to be used; the client notifies the streaming adapter of this change. The client may require additional functionality or programming in order to detect and notify the streaming adapter of the change.

Dynamic configuration data may arrive at the initiation of a network component, in such case the relevant network component notifies the streaming adapter of this change. Such a network component may require additional functionality or programming in order to detect and notify the streaming adapter of the change. For example, the load on a component such as a network component may change, allowing for a different data compression regime to be used, or allowing for a different routing scheme to be used. In response to a change in network capabilities, the streaming adapter may modify the methods for converting more than one data stream currently being converted. For example, all data streams using a certain network may require more or less compression in response to a change in load on that network.

Dynamic configuration data may arrive at the initiation of the streaming adapter. The streaming adapter may query or poll various network components. Such polling may be regular (e.g., periodic) or, for example, may be in response to a change in conditions requiring up-to-date information. In alternate embodiments, other components may be polled, or may send information regarding, configuration information.

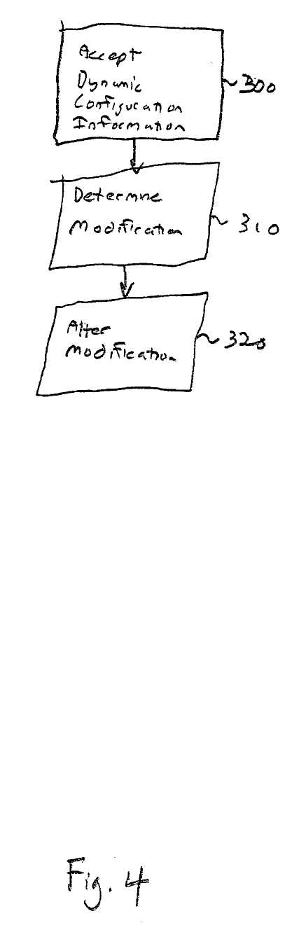

FIG. 4 is a flowchart showing a portion of the steps for modifying a data stream according an embodiment of the present invention.

Referring to FIG. 4, in step 300, the streaming adapter accepts dynamic configuration information. Such dynamic configuration information may be as a result of a poll of a component, as a result of a component initiating an information exchange, or may be as a result of other actions.

In step 310, the streaming adapter determines whether and how to modify the data stream. The streaming adapter considers the factors described in step 240, above. In some cases, updated configuration data may not require a change to any or all of the one or more data streams being converted.

In step 320, the streaming adapter alters the way that it modifies the data stream or data streams. The streaming adapter considers the factors described in step 250, above. For each modified data stream, the streaming adapter continues to send the data stream to a client or clients, but uses the updated methods.

In alternate embodiments, a streaming adapter can operate in different manners. For example, a server may cooperate directly with a streaming adapter to service requests, without the cooperation of a network controller. Client requests received by a server may be forwarded to a streaming adapter. A server, a client, or a network controller need not have knowledge of the streaming adapter. The streaming adapter can effect its functionality without the active participation of such components.

It will be appreciated by persons skilled in the art that the present invention is not limited by what has been particularly shown and described hereinabove. Alternate embodiments are contemplated which fall within the scope of the invention.

1. A method comprising:
accepting a set of configuration parameters;
accepting a data stream from a server;
transforming the data stream in response to the configuration parameters;
and transmitting the transformed data stream to a data stream client.

2. The method of claim 1 wherein the configuration parameters reflect the capabilities of a network that transmits information between the server and the data stream client.

3. The method of claim 2 wherein the capabilities of the network include bandwidth information for the network.

4. The method of claim 2 wherein the capabilities of the network include load information for the network.

5. The method of claim 1 wherein the configuration parameters reflect the capabilities of the data stream client.

6. The method of claim 1 wherein the capabilities of the data stream client reflect the amount of data the data stream client may accept in a data stream.

7. The method of claim 1 wherein the capabilities of the data stream client reflect the compression capabilities of the client.

8. The method of claim 1 wherein the capabilities of the data stream client reflect the number of data streams the client may accept.

9. The method of claim 1 comprising:
accepting the data request of a second client; and
modifying the manner in which the data stream is transformed when sent to the data stream client.

10. The method of claim 1 wherein the data stream is audio streaming data.

11. The method of claim 1 wherein the data stream is video streaming data.

12. The method of claim 1, wherein the transformation is transcoding.

13. The method of claim 1, wherein the configuration parameters include information on data stream requests.

14. A method comprising:
accepting a set of configuration parameters;
accepting a data stream from a server;
transcoding the data stream in response to the configuration parameters; and
transmitting the transcoded data stream to a data stream client.

15. A method comprising:
accepting a set of configuration parameters including information on client capabilities and network component capabilities;
accepting a data stream from a server;
transforming the data stream in based on the configuration parameters; and
transmitting the transformed data stream to a data stream client.

16. A device for converting streaming data sent by a server to a set of clients, the device comprising:
a data converter; and
a configuration memory holding data on the capabilities of a subset of the clients;
wherein the data converter converts the data stream into an output data stream for transmission to a client based on the capabilities of a client.

17. The device of claim 16, wherein the data converter includes at least a digital signal processor.

18. The device of claim 16, wherein the device accepts configuration changes and, in response to such changes, alters the data conversion.

19. A device for converting streaming data sent by a server to a set of clients, the device comprising:
a data converter; and
a configuration memory holding data on the capabilities of a set of networks;
wherein the data converter converts the data stream into an output data stream for transmission to a client based on the capabilities of the networks.

20. The device of claim 19, wherein the data converter includes at least a digital signal processor.

21. The device of claim 19, wherein the data converter converts the data stream into an output data stream for transmission to a client based on the capabilities of a client.

22. The device of claim 19, wherein the device accepts configuration changes and, in response to such changes, alters the data conversion.

23. The device of claim 22, wherein the configuration changes include information on client capabilities.

24. The device of claim 22, wherein the configuration changes include information on network capabilities.

25. The device of claim 20, wherein the configuration changes include information on data stream requests.
